(19) United States
(12) Patent Application Publication
(10) Pub. No.: US 2015/0136637 A1
(43) Pub. Date: May 21, 2015

(54) WATER-SOLUBLE PACKAGING AND PRODUCTION METHOD THEREOF

(71) Applicant: Henkel AG & Co. KGaA, Duesseldorf (DE)

(72) Inventors: Frank Meier, Duesseldorf (DE); Matthias Sunder, Duesseldorf (DE); Ralph Butter-Jentsch, Langenfeld (DE); Ulf Arno Timmann, Duesseldorf (DE)

(21) Appl. No.: 14/602,350

(22) Filed: Jan. 22, 2015

Related U.S. Application Data
(63) Continuation of application No. PCT/EP2013/052843, filed on Feb. 13, 2013.

(30) Foreign Application Priority Data
Jul. 23, 2012 (DE) 10 2012 212 842.5

(51) Int. Cl. C11D 17/04; B65B 51/04; B65B 47/00

(52) U.S. Cl. CPC C11D 17/045; B65B 47/00; B65B 51/04; C11D 17/043
USPC 206/524.7; 53/415

(57) ABSTRACT

The application describes a water-soluble package that contains an agent and a water-soluble envelope, in which at least one strip of film made of a water-soluble material is arranged by material attachment on the outer surface of the package.

### FIELD OF THE INVENTION

The present invention generally relates to a water-soluble package that comprises an agent and a water-soluble envelope. The invention also relates to a method for manufacturing a water-soluble package.

### BACKGROUND OF THE INVENTION

Washing or cleaning agents are obtainable by consumers nowadays in a wide variety of presentation forms. In addition to powders and granulates, these presentations also include, for example, liquids, gels, or portion packages (tablets or filled bags).

Portion packages in the form of water-soluble packages having liquid washing or cleaning agents are in particular becoming increasingly popular: on the one hand they meet the consumer's desire for simplified dispensing, and on the other hand more and more consumers prefer liquid washing or cleaning agents.

Desirable features and characteristics of the present invention will become apparent from the subsequent detailed description of the invention and the appended claims, taken in conjunction with the accompanying drawings and this background of the invention.

### BRIEF SUMMARY OF THE INVENTION

A water-soluble package that contains an agent and a water-soluble envelope, characterized in that at least one strip of film made of a water-soluble material is arranged by material attachment on the outer surface of the package.

A water-soluble package that contains an agent and a water-soluble envelope, characterized in that at least one strip of film made of a water-soluble material is arranged by material attachment on the inner surface of the package.

A method for manufacturing a water-soluble package that contains an agent and a water-soluble envelope, comprising the steps of: a) forming at least one cavity in a water-soluble film web, b) filling the at least one cavity with an agent, c) closing off the cavity with a water-soluble film web, d) moistening a water-soluble strip of film, and e) pressing the moistened water-soluble strip of film onto the water-soluble package.

A method for manufacturing a water-soluble package that contains an agent and a water-soluble envelope, comprising the steps of: a) moistening a water-soluble strip of film, b) pressing the moistened water-soluble strip of film onto the outer and/or inner surface of a water-soluble film web, c) forming at least one cavity in the water-soluble film web constituted in process step b), d) filling the at least one cavity with an agent, and e) closing off the cavity with a water-soluble film web.

A method for manufacturing a water-soluble package that contains an agent and a water-soluble envelope, comprising the steps of: a) moistening a water-soluble strip of film, b) pressing the moistened water-soluble strip of film onto the inner or outer surface of a water-soluble film web, c) forming at least one cavity in a water-soluble film web, d) filling the at least one cavity with an agent, and e) closing off the cavity with the water-soluble film web constituted in process step b).

A method for manufacturing a water-soluble package that contains an agent and a water-soluble envelope, comprising the steps of: a) moistening a water-soluble strip of film, b) forming at least one cavity in a water-soluble film web, c) pressing the moistened water-soluble strip of film onto the inner or outer surface of the water-soluble film web constituted in process step b), d) filling the at least one cavity with an agent, and e) closing off the cavity with a water-soluble film web.

### BRIEF DESCRIPTION OF THE DRAWINGS

The present invention will hereinafter be described in conjunction with the following drawing figures, wherein like numerals denote like elements, and

FIG. 1 shows a water-soluble package having a strip of film;

FIG. 2 shows a water-soluble package having two strips of film;

FIG. 3 shows a water-soluble package having a flag-like strip of film;

FIG. 4 shows a water-soluble package having a flag-like strip of film;

FIG. 5 shows a water-soluble package having a flag-like strip of film;

FIG. 6 shows a water-soluble package having a loop-like strip of film;

FIG. 7 shows a water-soluble package having a loop-like strip of film; and

FIG. 8 is a cross-sectional view of a strip of film having a cover layer.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

According to a first embodiment, the water-soluble package comprises an agent and a water-soluble envelope, at least one strip of film made of a water-soluble material being arranged by material attachment on the outer surface of the package.

In an embodiment alternative thereto, the water-soluble package comprises an agent and a water-soluble envelope, at least one strip of film made of a water-soluble material being arranged by material attachment on the inner surface of the package.

It is of course possible to combine the aforementioned alternative embodiments, thereby constituting a water-soluble package that comprises at least one strip of film made of a water-soluble material on the inner and on the outer surface of the package.

It is furthermore preferred that the strip of film be imprinted. The imprinting′ can contain written or also visual instructions for the user of the water-soluble package, or can contain ornamental or graphic elements, for example floral illustrations. The strip of film can in particular also be imprinted with a manufacturer advisory.

The strip of film is, in particular, embodied to be transparent, translucent, or opaque.

According to a particularly advantageous embodiment of the invention, the strip of film is a carrier of an active substance, in particular of a scent. It is thereby possible to convey to a user, for example, a corresponding scent impression of the preparation stored in the water-soluble package.

It is preferred for the strip of film to cover between 10% and 90% of the surface of the water-soluble package.

It is also advantageous for the strip of film to be connected by material attachment, with 5 to 100% of its surface, to the inner or outer surface of the water-soluble package.

According to a further, preferred embodiment of the invention, the strip of film comprises two adhesion points spaced apart from one another which are attached on the outer surface of the water-soluble package in such a way that the strip of film forms a loop.

The water-soluble film bag can preferably also comprise between two and five chambers.

It is also possible for a plurality of strips of film to be arranged on and/or in the water-soluble package, wherein the strips of film preferably differ from one another in terms of their imprinting and/or the active substance contained.

A preferred method for manufacturing a water-soluble package that contains an agent and a water-soluble envelope is one comprising the steps of:
a) forming at least one cavity in a water-soluble film web,
b) filling the at least one cavity with an agent,
c) closing off the cavity with a water-soluble film web,
d) moistening a water-soluble strip of film, and
e) pressing the moistened water-soluble strip of film onto the water-soluble package.

A particularly preferred method for manufacturing the water-soluble package according to the present invention that contains an agent and a water-soluble envelope is one comprising the steps of:
a) moistening a water-soluble strip of film,
b) pressing the moistened water-soluble strip of film onto the outer and/or inner surface of a water-soluble film web,
c) forming at least one cavity in the water-soluble film web constituted in process step b),
d) filling the at least one cavity with an agent, and
e) closing off the cavity with a water-soluble film web.

A preferred method for manufacturing the water-soluble package according to the present invention that contains an agent and a water-soluble envelope can be one comprising the steps of:
a) moistening a water-soluble strip of film,
b) pressing the moistened water-soluble strip of film onto the inner or outer surface of a water-soluble film web,
c) forming at least one cavity in a water-soluble film web,
d) filling the at least one cavity with an agent, and
e) closing off the cavity with the water-soluble film web constituted in process step b).

Another particularly preferred method for manufacturing the water-soluble package according to the present invention that contains an agent and a water-soluble envelope is one comprising the steps of:
a) moistening a water-soluble strip of film,
b) forming at least one cavity in a water-soluble film web,
c) pressing the moistened water-soluble strip of film onto the inner or outer surface of the water-soluble film web constituted in process step b),
d) filling the at least one cavity with an agent, and
e) closing off the cavity with a water-soluble film web.

### Water-Soluble Package

A subject of the invention is a water-soluble package that contains an agent and a water-soluble envelope.

A water-soluble package contains a water-soluble envelope that constitutes a closed structure that comprises in its interior one or more chambers for receiving one or more agents. The water-soluble envelope is preferably constituted by a water-soluble film material.

The water-soluble package can be dimensionally stable or deformable.

According to a first preferred embodiment, the water-soluble package is embodied as a dimensionally stable container, for example in the form of a capsule, box, can, or receptacle.

It is in principle also possible, however, and preferred, to configure the container as a dimensionally unstable container, for example as a bag. The shape of a film bag of this kind can be largely adapted to utilization conditions. For example, plastic films or panels, capsules, and other conceivable forms, worked or processed into various shapes (such as tubes, pillows, cylinders, bottles, disks, or the like) are appropriate. Films that can be adhesively bonded and/or sealed to yield packages such as tubes, pillows, or the like once they have been filled with an agent are particularly preferred according to the present invention.

The water-soluble package can comprise one or more chambers for storing one or more agents. The water-soluble package preferably comprises between two and five chambers.

### Water-Soluble Envelope

The water-soluble envelope is preferably constituted from a water-soluble film material selected from the group consisting of polymers or polymer mixtures. The envelope can be constituted from one or from two or more plies of the water-soluble film material. The water-soluble film material of the first ply and of the further plies, if present, can be the same or different.

It is preferred for the water-soluble envelope to contain polyvinyl alcohol or a polyvinyl alcohol copolymer. Water-soluble envelopes that contain polyvinyl alcohol or a polyvinyl alcohol copolymer exhibit good stability with sufficiently high water solubility, in particular cold-water solubility.

Suitable water-soluble films for manufacturing the water-soluble envelope are based preferably on a polyvinyl alcohol or on a polyvinyl alcohol copolymer whose molecular weight is in the range from 10,000 to 1,000,000 gmol⁻¹, preferably from 20,000 to 500,000 gmol⁻¹, particularly preferably from 30,000 to 100,000 gmol⁻¹, and in particular from 40,000 to 80,000 gmol⁻¹.

The manufacture of polyvinyl alcohol is usually accomplished by hydrolysis of polyvinyl acetate, since the direct synthesis pathway is not possible. The same applies to polyvinyl alcohol copolymers, which are manufactured correspondingly from polyvinyl acetate copolymers. It is preferred if at least one ply of the water-soluble envelope comprises a polyvinyl alcohol whose degree of hydrolysis is equal to 70 to 100 mol %, preferably 80 to 90 mol %, particularly preferably 81 to 89 mol %, and in particular 82 to 88 mol %.

A polyvinyl alcohol-containing film material suitable for manufacturing the water-soluble envelope can additionally have added to it a polymer selected from the group comprising (meth)acrylic acid-containing (co)polymers, polyacrylamides, oxazoline polymers, polystyrene sulfonates, polyurethanes, polyesters, polyethers, polylactic acid, or mixtures of the aforesaid polymers.

Besides vinyl alcohol, preferred polyvinyl alcohol copolymers comprise dicarboxylic acids as further monomers. Suitable dicarboxylic acids are itaconic acid, malonic acid, succinic acid, and mixtures thereof, itaconic acid being preferred.

Polyvinyl alcohol copolymers that are likewise preferred comprise, besides vinyl alcohol, an ethylenically unsaturated carboxylic acid or a salt or ester thereof. Besides vinyl alcohol, such polyvinyl alcohol copolymers particularly preferably contain acrylic acid, methacrylic acid, acrylic acid esters, methacrylic acid esters, or mixtures thereof.

It can be preferred for the film material to contain further additives. The film material can contain, for example, plasticizers such as dipropylene glycol, ethylene glycol, diethylene glycol, propylene glycol, glycerol, sorbitol, mannitol, or mixtures thereof. Further additives comprise, for example, release aids, fillers, crosslinking agents, surfactants, antioxidants, UV absorbers, antiblocking agents, anti-adhesion agents, or mixtures thereof.

Suitable water-soluble films for use in the water-soluble envelopes of the water-soluble packages according to the invention are films that are marketed by MonoSol LLC under the Monosol M8630, C8400, or M8900 designation. Other suitable films comprise films having the designations Solublon® PT, Solublon® GA, Solublon® KC, or Solublon® KL of Aicello Chemical Europe GmbH, or the VF-HP films of Kuraray.

According to a further embodiment of the invention, the water-soluble film can be constituted at least in part from a pulp-based material. The pulp-based material can in particular be a water-soluble paper. It is particularly preferable in this connection for the water-soluble film to be constituted entirely from a water-soluble paper. It is especially preferred for the water-soluble paper to be imprinted.

### Strip of Film

The strip of film is constituted from a water-soluble material, in particular from a water-soluble film. Reference is made in this regard to the section above regarding the water-soluble envelope.

The strip of film can be constituted from the same water-soluble film that is used in the water-soluble envelope. It is also conceivable, however, to constitute the strip of film from a water-soluble film that is different from the water-soluble film that is used in the water-soluble envelope.

The strip of film can assume any desired planar geometric configuration. Rectangular, square, oval, round basic shapes are particularly preferred. It is also possible, however, to configure the strip of film in ornamental fashion, e.g. in the shape of a flower, a blossom, an animal, or the like.

It is preferred for the strip of film to be imprinted. It is particularly preferable in this context for the imprinting of the strip of film to be water-soluble.

The imprinting can preferably comprise writing and/or symbols and/or shapes. The imprinting in particular can serve as an indication of the origin of the water-soluble package, for example by printing a trademark and/or product name. The imprinting can furthermore be embodied as a use instruction and/or warning instruction in conjunction with the water-soluble package.

Methods for imprinting the water-soluble strip of film are known from the existing art. Any type of imprinting can be used in principle, for example rotogravure, lithography, flexography, inkjet printing, pad printing, or any combinations of these printing technologies.

The strip of film is imprinted preferably using a water-soluble ink or another suitable water-soluble color. Water-soluble inks are known, for example, under the trade name SunChemical Aquadestruct of the SunChemical company, Aqua Poly Super Opaque White QW000046 of the Environmental Inks Company, or Opta Film OPQ White W0L009656 of the Water Ink Technologies Company.

Alternatively, the strip of film can be colored using a color-imparting substance that is a dye, a pigment, or a luster agent. Suitable dyes comprise dyes that are referred to in the Color Index (CI) classification as an Acid Dye, Direct Dye, or Basic Dye.

Suitable pigments that are contained in the film material are, for example, ultramarine or titanium dioxide.

Luster agents that can be contained in the film material are mica, metal oxide-coated mica, silica-coated mica, bismuth oxychloride-coated mica, bismuth oxychloride, glass, metal oxide-coated glass, polyester glitter, and/or metal glitter.

In order to provide additional mechanical protection in particular from rub-off, the imprinted side of the strip of film can be covered by a water-soluble film, said cover film being in particular embodied in transparent fashion so that the printed image of the strip of film is visible. The strip of film and the cover layer can be joined to one another by material attachment, for example by means of fastening spots, or by way of a peripheral connecting edge or a partial- or full-coverage connection. The connection can be embodied by means of a separate adhesive or by slight moistening of at least one of the water-soluble films.

Alternatively to a cover layer, constituted from a water-soluble film, of an imprinted strip of film, the imprinted strip of film can also be equipped with a water-soluble lacquer that, for example, is sprayed onto the printed image. The lacquer is preferably transparent, so that the printed image of the strip of film remains visible.

The strip of film can be transparent, translucent, or opaque.

It is advantageous for the strip of film to cover between 10% and 90% of the inner or outer surface of the water-soluble package, thereby providing a sufficiently large contact area for material attachment between the surfaces of the water-soluble package and of the strip of film

It is furthermore possible to arrange a plurality of strips of film on and/or in the water-soluble package, the strips of film preferably being different from one another in terms of their imprinting and/or the active substance contained.

The strip of film can also be connected in flag-like fashion to the water-soluble package, being connected by material attachment, with 5 to 100% of its surface, to the inner or outer surface of the water-soluble package. An adhesion spot is provided close to the outer edge of the strip of film.

In order to configure a loop on the water-soluble package with the aid of the strip of film, it is preferred that the strip of film be connected on the outer surface of the water-soluble package with two adhesion spots spaced apart from one another, in such a way that the strip of film in fact forms such a loop. The loop can serve in particular as a grasping aid for a user.

It is particularly advantageous in this connection that the adhesion spots are constituted by means of a water-soluble adhesive, for example an acrylate contact adhesive.

### Active Substance in or on Strip of Film

In a refinement according to the present invention of the water-soluble package, the strip of film is a carrier of an active substance, in particular of a scent or a scent composition. A further preferred active substance is a bluing agent.

### Scent Composition

Scents are added to agents, in particular to washing or cleaning agents, in order to improve the overall aesthetic impression of the products and to make available to the user, in addition to technical performance (e.g. cleaning performance), a product that is visually and sensorially typical and unmistakable. Water-soluble packages usually possess the property, however, that scent compositions are discharged poorly or not at all from the agents stored in them through the water-soluble envelope to the environment. The scent impression of such agents stored in water-soluble packages can thus not be perceived, or can be perceived very unsatisfactorily, by a user. It is therefore advantageous for a scent or a scent composition to be comprised in or on the strip of film as an active substance.

Individual compounds, e.g. synthetic products of the ester, ether, aldehyde, ketone, alcohol, and hydrocarbon types, can be used as scents. Fragrance compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate, and benzyl salicylate. Ethers include, for example, benzyl ethyl ether; aldehydes, for example, linear alkanals having 8 to 18 carbon atoms, citral, citronellal, citronellyloxyacetaldehyde, cyclamenaldehyde, hydroxycitronellal, lilial, and bourgeonal. Ketones include, for example, the ionones, α-isomethylionone, and methyl cedryl ketone. Alcohols include, for example, anethole, citronellol, eugenol, geraniol, linalool, phenylethyl alcohol, and terpineol. Hydrocarbons include principally terpenes such as limonene and pinene.

It is preferred to use scent compositions of different scents, which are coordinated with one another so that together they produce an attractive scent note. Scent compositions of this kind can also contain natural scent mixtures such as those accessible from plant-based sources.

### Bluing Agent

It has been usual for some time to improve the whiteness of textiles with the aid of optical brighteners or bluing agents. These compositions are intended in particular to compensate for a yellow tint of white textiles which occurs over time. Bluing involves the use, at very low concentrations, of blue or blue-violet dyes having a low fiber affinity, in order to achieve an even coloring of the textiles which is not visible to the naked eye. The improved white effect achieved with bluing is based on a decrease in the yellow components of the light reflected into the observer's eye.

Bluing agents are used at only a low concentration in order to prevent the bluing agent from building up on the textiles. The quantity of bluing agent used can be better controlled by dispensing via the strip of film.

Suitable bluing agents are, for example, dyes that are referred to in the Color Index (CI) classification as Direct Blue, Direct Red, Direct Violet, Acid Blue, Acid Red, Acid Violet, Basic Blue, Basic Violet, or Basic Red. Alternatively, polymeric dyes such as those obtainable e.g. from the Milliken company under the designation “Liquitint (R)”. Pigments such as ultramarine are also suitable as a bluing agent.

Particularly preferred bluing agents are Basic Violet 10, ultramarine, Liquitint(R) Blue HP, or compounds of the following formula:

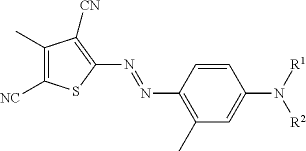

in which each R¹ and R² is mutually independently selected from R, [(CH₂CR′HO)ₓ(CH₂CR″HO)_{y}H], and mixtures thereof, in which each R is selected mutually independently from hydrogen, linear or branched C₁ to C₄ alkyl groups, benzyl, and mixtures thereof; each R′ is selected mutually independently from hydrogen, CH₂O(CH₂CH₂O)_{z}H, and mixtures thereof; and each R is selected mutually independently from hydrogen, CH₃, CH₂O(CH₂CH₂O)_{z}H, and mixtures thereof; in which x+y<5, y≧1, and z=0 to 5.

### Agents, in Particular Liquid, Gelled, or Solid Washing or Cleaning Agents, for Storage in the Water-Soluble Package

Besides the water-soluble envelope, the water-soluble package comprises an agent. This agent can be, for example, a solid agent and can comprise a powder, a granulate, or a tablet. Alternatively, the agent can be a liquid agent and can comprise a gel or a liquid. Particularly preferably, the agent is a liquid or solid washing or cleaning agent.

In an embodiment, the water-soluble package comprises a chamber for receiving the agent. In this embodiment the agent can preferably comprise a powder, a granulate, a gel, or a liquid.

In a further embodiment the water-soluble package comprises two chambers. In this embodiment the first chamber preferably contains a liquid agent and the second chamber contains a solid agent or a liquid agent. Alternatively, both chambers can contain a solid agent.

If the water-soluble package comprises three chambers, they can all respectively contain a liquid agent or a solid agent. It is also possible, however, for one chamber to contain a solid agent and two chambers to contain a liquid agent. It is furthermore possible for a solid agent to be contained in two chambers, and a liquid agent to be contained in one chamber.

With water-soluble packages having four or more chambers, even more possible combinations correspondingly exist regarding the number of chambers having a solid agent or a liquid agent.

The agents that are contained in the different chambers of a water-soluble package can have the same composition. The agents in a water-soluble package having at least two chambers preferably have compositions that differ in terms of at least one ingredient.

The agent contains ingredients that do not destroy the structural integrity of the water-soluble envelope. If the agent used is a liquid or solid washing or cleaning agent, it can contain one or more substances from the group of surfactants, builders, bleaching agents, bleach activators, bleach catalysts, enzymes, enzyme stabilizers, electrolytes, pH adjusting agents, perfumes, perfume carriers, fluorescent agents, dyes, hydrotopes, foam inhibitors, silicone oils, anti-redeposition agents, anti-gray agents, shrinkage preventers, crease prevention agents, color transfer inhibitors, antimicrobial active agents, nonaqueous solvents, germicides, fungicides, antioxidants, preservatives, corrosion inhibitors, antistatic agents, bittering agents, ironing adjuvants, proofing and impregnation agents, opacifiers, skin-care active agents, swelling and anti-slip agents, softening components, fillers, and UV absorbers.

The liquid washing or cleaning agents can contain water, the water content being less than 10 wt % and more preferably less than 8 wt %, based in each case on the total liquid washing or cleaning agent.

### Methods for Manufacturing a Water-Soluble Bag

Several alternative methods exist for manufacturing the water-soluble package according to the present invention.

According to a first alternative method for manufacturing a water-soluble package having an externally located strip of film, it comprises the steps of:
a) forming at least one cavity in a water-soluble film web,
b) filling the at least one cavity with a product,
c) closing off the cavity with a water-soluble film web,
d) moistening a water-soluble strip of film, and
e) pressing the moistened water-soluble strip of film onto the water-soluble package.

It is also alternatively possible to configure the method for manufacturing a water-soluble bag having an internally and/or externally applied strip of film in such a way that it comprises the following steps:
a) moistening a water-soluble strip of film,
b) pressing the moistened water-soluble strip of film onto the outer and/or inner surface of a water-soluble film web,
c) forming at least one cavity in the water-soluble film web constituted in process step b),
d) filling the at least one cavity with a product, and
e) closing off the cavity with a water-soluble film web.

In a further alternative embodiment of the method according to the present invention for manufacturing a water-soluble package having an internally and/or externally applied strip of film, the method comprises the steps of:
a) moistening a water-soluble strip of film,
b) pressing the moistened water-soluble strip of film onto the inner and/or outer surface of a water-soluble film web,
c) forming at least one cavity in a water-soluble film web,
d) filling the at least one cavity with a product, and
e) closing off the cavity with the water-soluble film web constituted in process step b).

Lastly, it is also possible to embody the method for manufacturing a water-soluble package having an internally and/or externally applied strip of film in such a way that it comprises the following steps:
a) moistening a water-soluble strip of film,
b) forming at least one cavity in a water-soluble film web,
c) pressing the moistened water-soluble strip of film onto the inner and/or outer surface of the water-soluble film web constituted in process step b),
d) filling the at least one cavity with a product, and
e) closing off the cavity with a water-soluble film web.

The invention will be explained in further detail below with reference to illustrations that merely depict exemplifying embodiments. In the drawings:

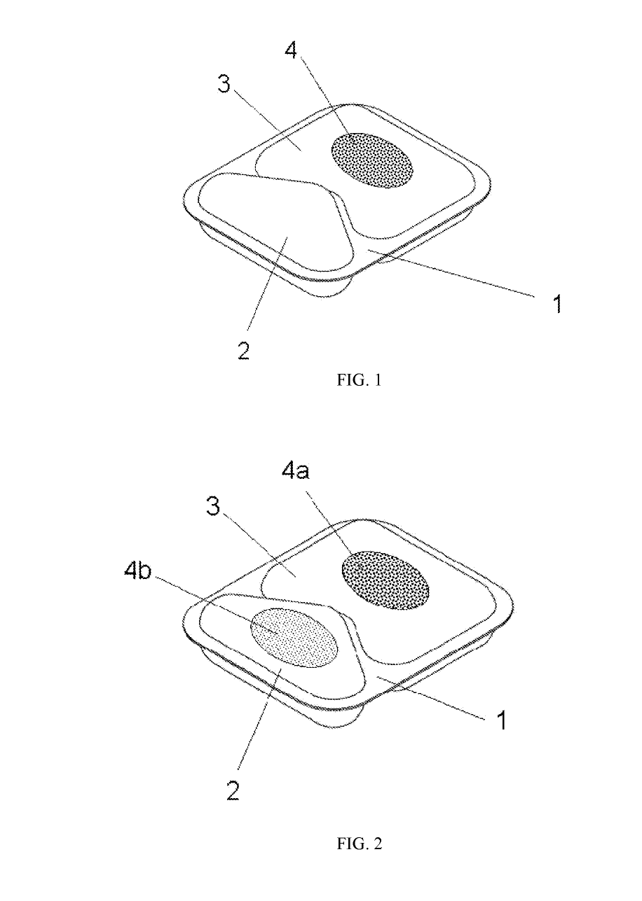

FIG. 1 shows a water-soluble package having a strip of film,

FIG. 2 shows a water-soluble package having two strips of film,

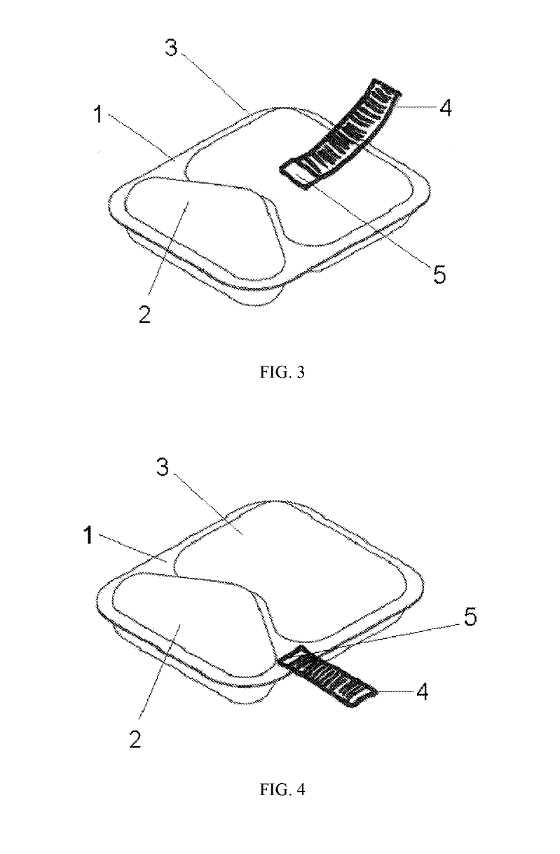

FIG. 3 shows a water-soluble package having a flag-like strip of film,

FIG. 4 shows a water-soluble package having a flag-like strip of film,

FIG. 5 shows a water-soluble package having a flag-like strip of film,

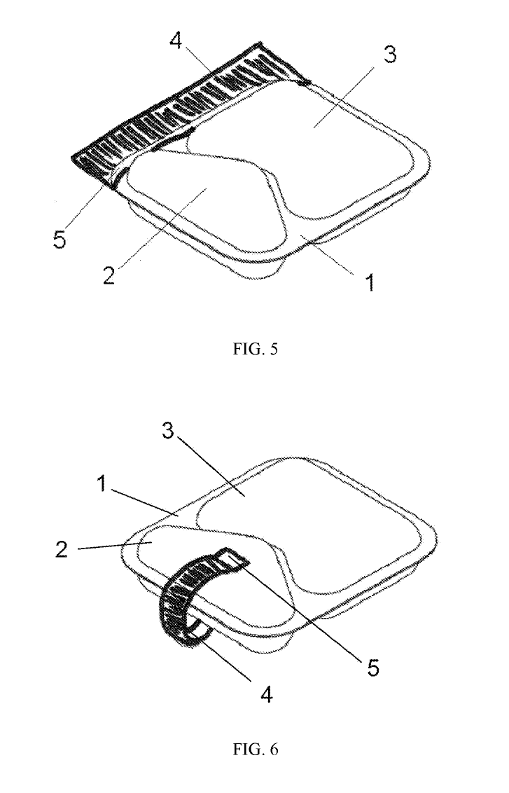

FIG. 6 shows a water-soluble package having a loop-like strip of film,

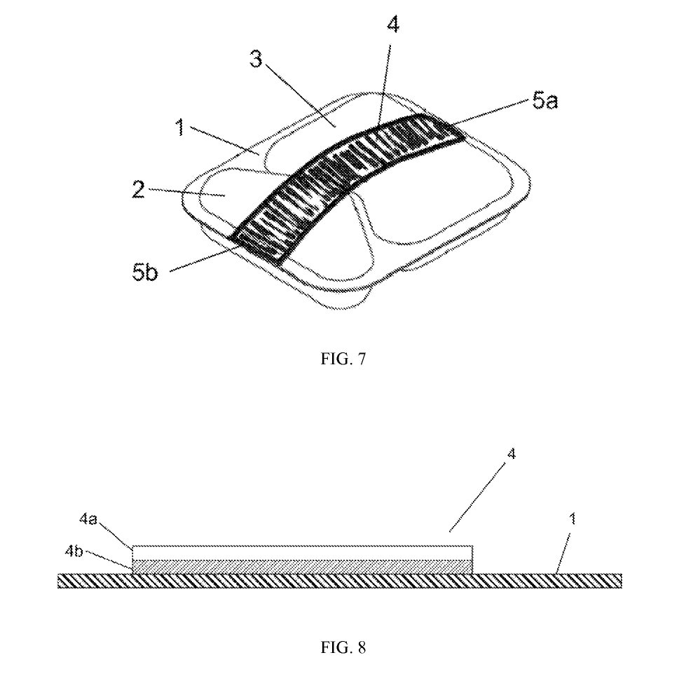

FIG. 7 shows a water-soluble package having a loop-like strip of film,

FIG. 8 is a cross-sectional view of a strip of film having a cover layer.

### LIST OF REFERENCE CHARACTERS

1 Water-soluble package
2 Chamber
3 Chamber
4 Strip of film
5 Connecting area

In the illustrations that follow, water-soluble packages having two chambers are described. The invention is of course equally suitable for water-soluble packages having one chamber or having more than two chambers, and is not limited to the two-chamber embodiments shown.

FIG. 1 shows a first exemplifying embodiment of a water-soluble package 1 according to the present invention. Water-soluble package 1 has a first chamber 2 for receiving a first agent, and a second chamber 3 for receiving a second agent. Water-soluble package 1 is constituted from a water-soluble film, the film being closed off by a peripheral sealing seam, thereby forming the first and the second chamber. An oval strip of film 4 is arranged by full-coverage material attachment on the outer surface of second chamber 3 of water-soluble package 1. Strip of film 4 has an imprinted area, as symbolized by the hatching of strip of film 4

It is of course also possible for each of the two chambers 2, 3 of package 1 known from FIG. 1 to carry a strip of film 4, as shown in FIG. 2. In this exemplifying embodiment the imprinting of first strip of film 4a differs from that of second strip of film 4b, which has again been made evident by the different hatching patterns.

In addition to connection of a strip of film 4 to water-soluble package 1 by full-coverage material attachment, it is also possible for the strip of film to be connected to the water-soluble package by material attachment over only part of its surface. This is explained in further detail with reference to some exemplifying embodiments in accordance with FIGS. 3 to 7.

FIG. 3 shows the two-chamber package known from FIGS. 1 to 2. On the outer surface of second chamber 3 of package 1, a strip of film 4 is connected to chamber 3 by material attachment only via connecting area 5, while the remaining areas of strip of film 4 have no connection to water-soluble package 1. Strip of film 4 is thus connected in flag-like fashion to water-soluble package 1. This type of configuration makes it possible, for example for strip of film 4 embodied in this flag-like fashion also to serve as a grasping element for a user. This is significant in that water-soluble packages 1 are sensitive to moisture, i.e. also to a user's wet or moist finger. If a water-soluble package 1 is grasped with wet fingers, undesired dissolution and leakage of the water-soluble package can occur. This risk is minimized if the user can grasp the package by strip of film 4 arranged in flag-like fashion, so that no direct contact occurs between the user's fingers and chambers 2, 3 of package 1. Although dissolution of strip of film 4 could also occur, this would have merely aesthetic disadvantages and would not result in a failure of package 1 as perceived by a user.

It is of course possible for a strip element 4 as known from FIG. 3, arranged in flag-like fashion on or at package 1, to be placed at any suitable location on the package. For example, a connecting area 5 could also be embodied between strip element 4 and package 1 e.g. on a portion of the sealing seam of water-soluble package 1, as shown in FIG. 4. Connecting area 5 can also, as shown in FIG. 5, extend over an entire edge length of a sealing seam. As a result of the contact area that is enlarged as compared with that in the preceding exemplifying embodiments, a particularly secure connection by material attachment can be achieved between strip of film 4 and water-soluble package 4.

In addition to a connecting area 5 that is embodied between strip of film 4 and package 1, it is also possible to provide two connecting areas 5 spaced apart from one another on the package; this will be explained below with reference to the exemplifying embodiments of FIGS. 6 and 7.

In FIG. 6, strip of film 4 is connected by its distal ends to a connecting area 5 at the top and bottom (not visible) of water-soluble package 1 in such a way that a loop is formed. This loop can serve as a grasping element for a user, so that he or she does not need to directly touch water-soluble package 1 with his or her fingers. In addition to the embodiment shown in FIG. 6, it is alternatively also possible to embody the loop in such a way that connecting areas 5a, 5b of strip of film 4 are arranged on the top side of water-soluble package 1.

FIG. 8 is a cross-sectional view of a strip of film 4b having a cover layer 4a. Strip of film 4b that is connected to water-soluble package 1 is imprinted. The imprinted strip of film 4b is covered with a transparent, water-soluble cover layer 4a so that the imprinted strip of film 4b is protected from mechanical influences or from direct exposure to water or water vapor.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A water-soluble package that contains an agent and a water-soluble envelope, wherein at least one strip of film made of a water-soluble material is arranged by material attachment on the outer surface of the package.

2. A water-soluble package that contains an agent and a water-soluble envelope, wherein at least one strip of film made of a water-soluble material is arranged by material attachment on the inner surface of the package.

3. The water-soluble package according to claim 1, wherein the strip of film is imprinted.

4. The water-soluble package according to claim 1, wherein the strip of film is transparent, translucent, or opaque.

5. The water-soluble package according to claim 1, wherein the strip of film is a carrier of an active substance.

6. The water-soluble package according to claim 1, wherein the strip of film covers between 10% and 90% of the surface of the water-soluble package.

7. The water-soluble package according to claim 1, wherein a plurality of strips of film are arranged on and/or in the water-soluble package, and wherein the strips of film differ from one another in terms of their imprinting and/or the active substance contained.

8. The water-soluble package according to claim 1, wherein the strip of film is connected by material attachment, with 5 to 100% of its surface, to the inner or outer surface of the water-soluble package.

9. The water-soluble package according to claim 1, wherein the strip of film is attached on the outer surface of the water-soluble package with two adhesion points spaced apart from one another, so that the strip of film forms a loop.

10. The water-soluble package according to claim 1, wherein the water-soluble film bag comprises between two and five chambers.

11. A method for manufacturing a water-soluble package that contains an agent and a water-soluble envelope, comprising the steps of:
a) forming at least one cavity in a water-soluble film web,
b) filling the at least one cavity with an agent,
c) closing off the cavity with a water-soluble film web,
d) moistening a water-soluble strip of film, and
e) pressing the moistened water-soluble strip of film onto the water-soluble package.

12. A method for manufacturing a water-soluble package that contains an agent and a water-soluble envelope, comprising the steps of:
a) moistening a water-soluble strip of film,
b) pressing the moistened water-soluble strip of film onto the outer and/or inner surface of a water-soluble film web,
c) forming at least one cavity in the water-soluble film web constituted in process step b),
d) filling the at least one cavity with an agent, and
e) closing off the cavity with a water-soluble film web.

13. A method for manufacturing a water-soluble package that contains an agent and a water-soluble envelope, comprising the steps of:
a) moistening a water-soluble strip of film,
b) pressing the moistened water-soluble strip of film onto the inner or outer surface of a water-soluble film web,
c) forming at least one cavity in a water-soluble film web,
d) filling the at least one cavity with an agent, and
e) closing off the cavity with the water-soluble film web constituted in process step b).

14. A method for manufacturing a water-soluble package that contains an agent and a water-soluble envelope, comprising the steps of:
a) moistening a water-soluble strip of film,
b) forming at least one cavity in a water-soluble film web,
c) pressing the moistened water-soluble strip of film onto the inner or outer surface of the water-soluble film web constituted in process step b),
d) filling the at least one cavity with an agent, and
e) closing off the cavity with a water-soluble film web.
